(19) United States
(12) Patent Application Publication
(10) Pub. No.: US 2011/0273118 A1
(43) Pub. Date: Nov. 10, 2011

(54) Power Factor Correction Circuit

(76) Inventors: David Bonner, Bethlehem, PA (US); Aidong Xu, Cambridge (GB)

(21) Appl. No.: 12/777,197

(22) Filed: May 10, 2010

(51) Int. Cl. G05F 1/70; H02P 27/00

(52) U.S. Cl. 318/400.3; 323/207

(57) ABSTRACT

A power factor correction circuit has a semiconductor integrated circuit and at least one very low Rds(on) MOSFET. The circuit also includes a silicon carbide diode for zero reverse recovery current.

### RELATED APPLICATIONS

This application claims priority to U.S. patent application Ser. No. 11/469,023 filed on Aug. 31, 2006, which in turned claimed priority to U.S. Provisional Patent Application Ser. No. 60/712,945 filed on Aug. 31, 2005 and U.S. Provisional Patent Application Ser. No. 60/725,775 filed on Oct. 11, 2005. The contents of all of these parent patent applications are hereby incorporated by reference in their entirety.

### FIELD OF THE INVENTION

The invention relates generally to power factor correction (PFC) circuits. In particular, the invention relates to a power factor correction circuit for the control electronics of a brushless motor.

### BACKGROUND OF THE INVENTION

The US Department of Energy has estimated that alternating current motors consume more than 65% of the electricity produced and total electricity sales in the US will increase at an average annual rate of 1.9%, from 3,481 billion kilowatt hours in 2001 to 5,220 billion kilowatt hours in 2025. With a reduction in electrical energy consumption by 33%, by today's measure, is equivalent to the total output of 840 fossil fuel-based power plants. Throughout the world, electricity is used at an average rate of 40 billion kilowatt-hours each day, with a projected average annual growth rate of 2.3% for the next 20 years.

With few exceptions, much of the electricity is not used in the form in which it was initially produced. Rather, it is reprocessed to provide the type of power needed in the technology that is being employed. Power electronics process and convert electrical power from one form to another. It is expected that up to 80% of electrical power will be processed by power electronics equipment and systems. Power factor correction circuits are an important part of electrical efficiency.

### BRIEF SUMMARY

The preferred embodiments of the invention provide improved electric efficiency compared to conventional PFC circuits, particularly those for brushless motors. The applications of brushless motors include air conditioners, refrigerators, power tools, washers, and dryers, and industrial power tools, such as angle grinders, to name a few. The preferred embodiments use a new PFC circuit, which may be combined with other highly efficient components, to electronically regulate a brushless motor.

Some motor control electronics accept all major international voltages, eliminating the need for having different control electronics and motors for many different countries. These embodiments may be applied to motor systems up to 5 kilowatts, but have particular application to the 1 to 2 kilowatt power range.

The PFC circuit design in the preferred embodiments is highly compact (smaller choke and power semiconductor devices and high efficiency). This is achieved through: a) very low Rds(on) MOSFETs (but still commercially viable); b) Silicon Carbine Diode (SIC Diode) for zero reverse recovery current; c) higher switching frequency (over 60 kHz), even under 110V supply, over 50 A current; and d) high switching frequency enabling much reduced choke size.

### BRIEF DESCRIPTION OF THE DRAWINGS

FIG. 1 is a block diagram of a motor control electronics in which the power factor correction circuit according to the preferred embodiments of the invention may be utilized.

FIG. 2 is a perspective view of a preferred implementation of the motor control electronics in FIG. 1.

FIG. 3 is a side view of the preferred implementation of the motor control electronics in FIG. 1, diagrammatically illustrating the connection of parts to a main heatsink.

FIG. 4 is a diagram of the microcontroller connections in the motor control electronics of FIG. 1.

FIGS. 5-7 are flowcharts showing the process implemented by the microcontroller in the motor control electronics of FIG. 1.

FIG. 8 is a circuit diagram of the motor control electronics including a preferred embodiment of the power factor correction circuit.

FIGS. 9A-9D are circuit diagrams of the power factor correction circuit according to a preferred embodiment of the invention.

### DETAILED DESCRIPTION OF THE PREFERRED EMBODIMENTS

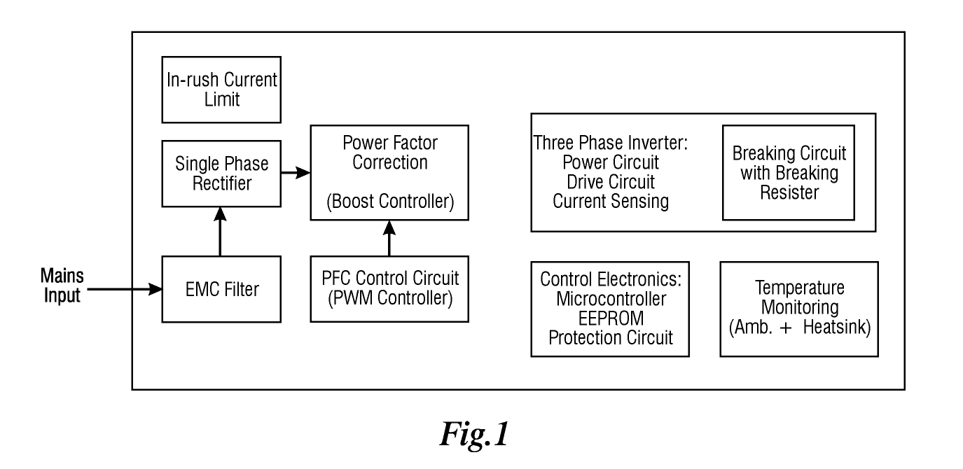

The preferred embodiments of the invention may be utilized in control electronics for brushless motors. The major building blocks of such control electronics are shown in FIG. 1 and described below and in the parent patent applications that are incorporated herein by reference in their entirety. Where specifics are provided, such as the identification of suitable parts, such specifics are illustrative and exemplary, and need not be utilized in a particular preferred embodiment.

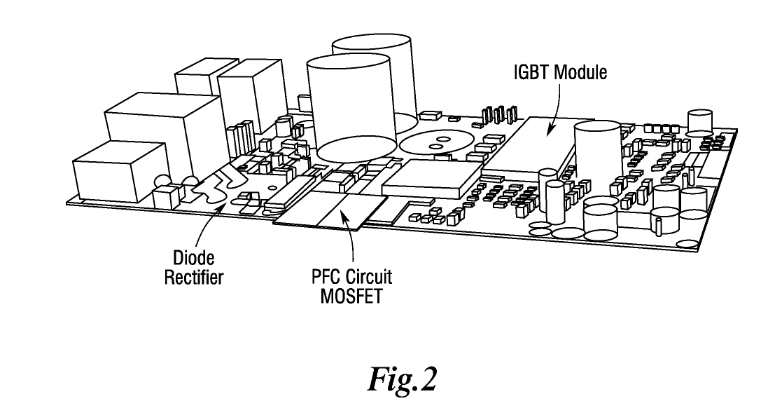

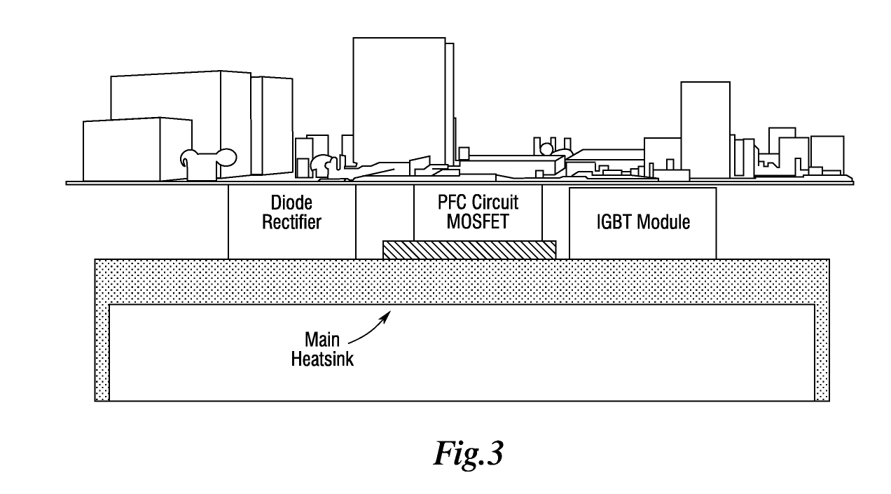

A very high power density is achieved by configuring all of the control electronics on a single printed circuit board. Optimally, the electronics are separated and divided into two parts. On the left side, there is input power control circuitry connected by a DC link to control circuitry and power output circuitry on the right side. A perspective view of an example layout implementation is shown in FIG. 2. The diode rectifier module, PFC Circuit MOSFET elements, and IGBT module dissipate the most amount of heat and the approximate location of these parts are shown in FIGS. 2 and 3. These parts are preferably located on the bottom side of the printed circuit board, while other components which have only a few watts loss are located on the other side of the printed circuit board. The heat from the low wattage components are dissipated through the air while the three main parts are preferably connected to a heatsink. The diode rectifier module and the IGBT module are directly connected to a main heatsink, whereas the MOSFET elements are mounted to a small heatsink via insulated pads, and then attached to the main heatsink as shown in FIG. 3.

In addition, the ambient temperature and power device (heatsink) temperature may also be monitored. In the event of device over-temperature, the drive will trip, the inverter output will be disabled and the motor will coast to a stop. The drive may include a signal interface with a motor thermal trip mechanism (may be a thermistor). If motor over temperature trip signal is received, the drive output stage can be disabled. A trip latching mechanism may be included so that when the drive has tripped (due to over temperature or other fault), it will not start again until after the operator presses an On/Off trigger from the ON position to OFF and back to ON again.

While the control electronics have a power rating of about 2 kilowatts, with overload capability, and work with both European (230V AC) and American (110V AC) supply voltages, they may be applied or adapted for motors up to about 5 kilowatts or with different supply voltage capabilities.

The input power control circuitry receives the main input and includes an EMC filter, and a single phase rectifier with in-rush current limiter. The input power control circuitry may or may not include the electronics disclosed in U.S. Pat. No. 7,088,066 issued on Aug. 8, 2006, which patent is hereby incorporated by reference in its entirety. The input power control circuitry also includes a power factor correction (PFC) circuit (which may include a boost converter), and a PFC control circuit, such as a PWM controller.

The EMC filter may be a common mode and differential mode EMC filter as shown in FIG. 3. The rectifier may be an input diode rectifier bridge used to convert single phase AC to DC. An IR GBPC3512W bridge rectifier (about 0.9V×2), or other rectifiers with a below average forward voltage drop, may be used.

The PFC circuit serves two main purposes: power factor correction and step up supply voltage. To limit the current and voltage phase-displacement introduced to the single phase main power supply, the power factor requirement is preferably 0.98 for the entire range of loads at both 110V AC and 230V AC. The maximum end of the load range is full load and the minimum end of the load range is experienced when the motor driven by the electronics is free running and may be about 20%.

For the inductor in the PFC circuit, the Coolu core is preferably used. As a power switching device, a STW45NM50FD may be used (two in parallel) for their low Rdson (0.08 ohm). Two in parallel will yield 0.04 ohms resistance. A NCP1650-D (On Semiconductor) is preferably used as the power factor controller, but the UC3845 (or newer 3817A) may also be used.

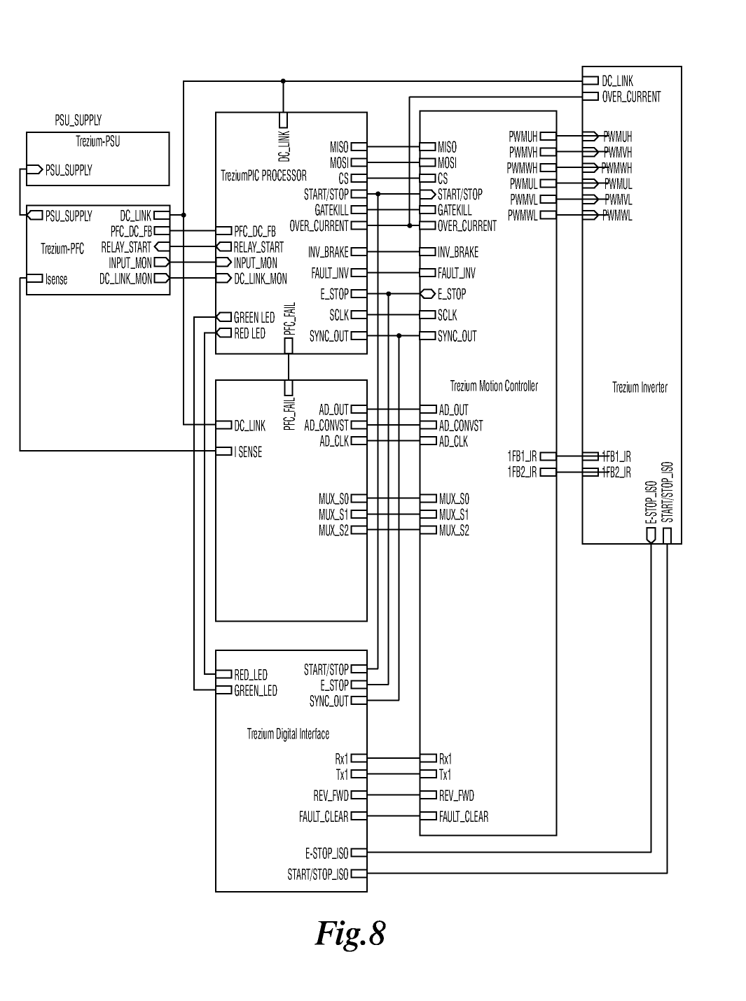

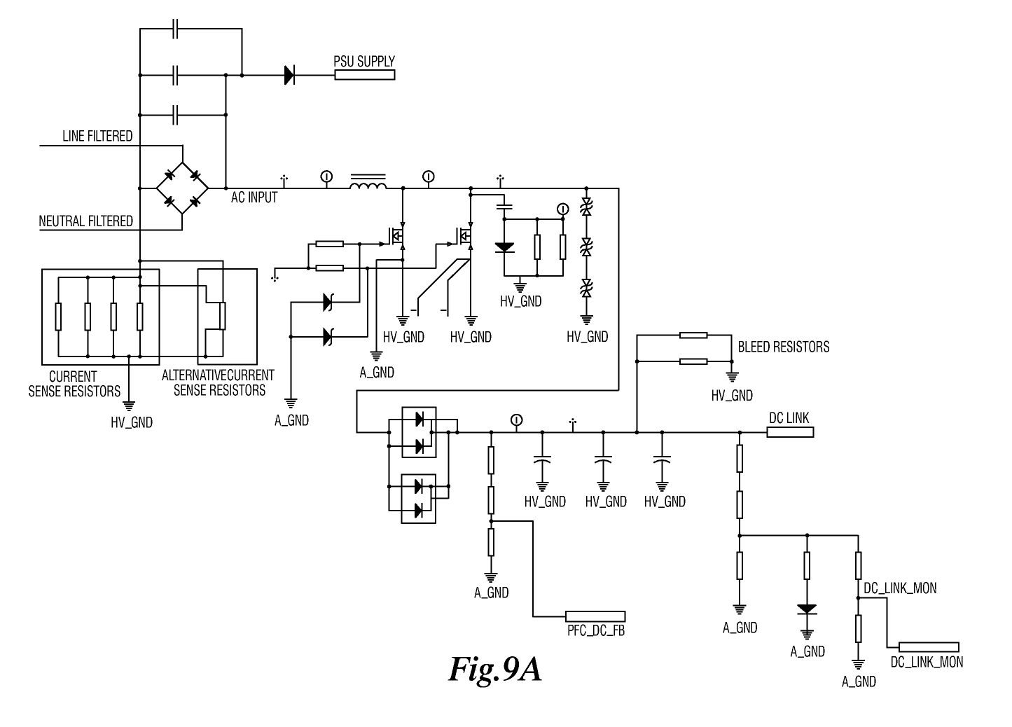

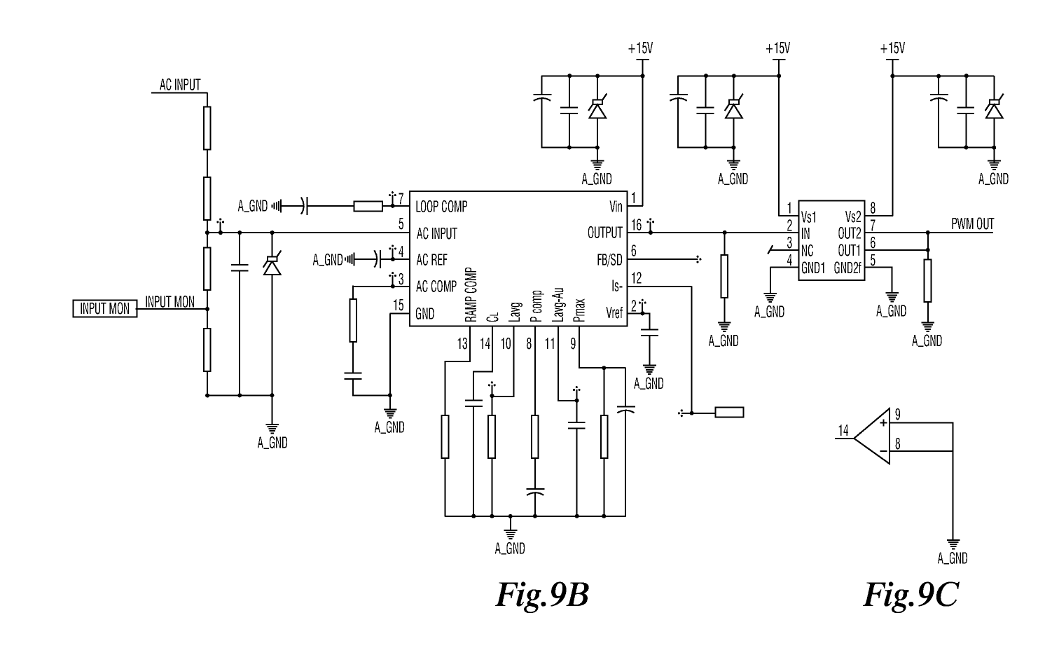

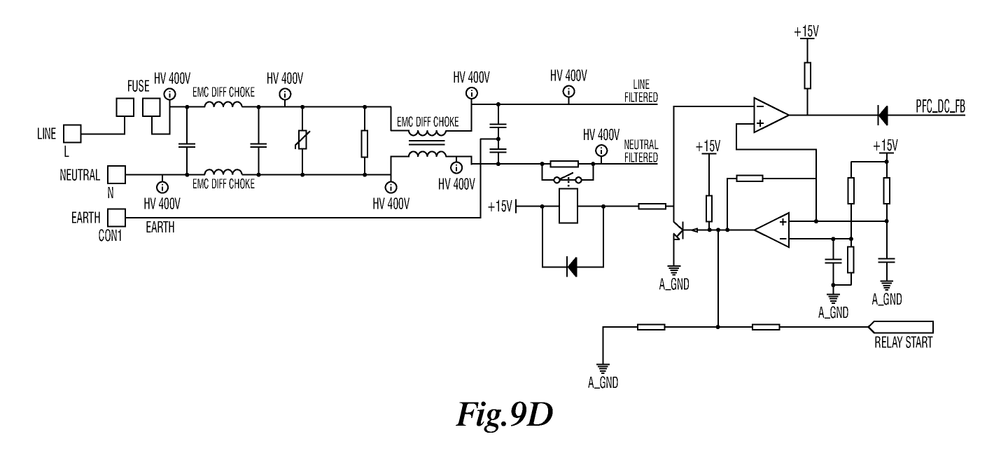

The circuit diagrams for the preferred embodiment are illustrated in FIGS. 8 and 9A-9D. A list of the referenced parts is provided in Provisional Patent Application No. 60/725,725 filed on Oct. 11, 2005 and incorporated herein by reference.

The control circuitry implements a new space vector control method. In this method, the controllability of the motor torque closely matches the load requirement and may be less affected by back-emf noise. It is also likely that the motor will have less vibrations, less torque ripple and better efficiency. This method may be implemented using software algorithms and a Digital Signal Processor (DSP) to carry out complex vector calculation.

In the application of the electronics to a motor, there are several aspects as follows. The motor will have a maximum speed, such as about 28,800-30,000 rpm. Preferably, the speed is selectable at the time of manufacture, rather than by the user, to be set at a level less than or equal to the maximum speed. Naturally, the power output is reduced when the selected speed is below rated speed.

The speed is preferably regulated so that under steady state conditions and up to the rated continuous maximum power, the drive will run the motor to the steady-state speed within +/−10% tolerance of the set point (subject to design), up to the maximum speed limit. It is expected that the motor speed will drop below maximum speed on reaching maximum power. In dynamic speed control with 50% load change, the variation of speed, as a percentage of steady-state speed, may be limited to a maximum deviation of +/−10% for example in a transient response defined by a recovery time period and to a maximum deviation of +/−1% within 50 ms of recovery to steady-state speed. Of course, the speed regulation may be modified in light of complex control loop bandwidth and motor-drive interactions and is a trade-off between the accuracy of steady-state speed and dynamic speed control.

The torque is preferably controlled during start-up and at steady-state in accordance with the smooth torque control profile in the following table, including smooth start-up. The drive electronics preferably deliver the required torque (within the limit of the power rating) at selected speed. When starting the motor, a starting torque of up to 150% of rated torque may be applied, if required. During motor acceleration, it is preferably NOT required that full torque will be available until the motor speed is over 10% of the final selected speed.

| Motor Speed | Motor Status | Available Torque | Duration* |
|---|---|---|---|
| Zero speed | Start-up | Upto 150% of | 1-2 seconds* |
| (parking) | | rated torque | |
| Between 0 and | Acceleration | Full rated torque | Depends on |
| 10% of | | may not be | acceleration rate |
| selected speed | | available | (soft start setting) |
| 10%-100% of | In acceleration or | Full rated torque | Continuous |
| selected speed | at steady state | | |
| | (running at the | | |
| | selected speed) | | |

The acceleration/soft start time (to rated speed) is preferably limited to, for example, 1.5 seconds. The deceleration time (from rated speed) is preferably limited to, for example, 5 seconds.

Due to the nature of the motor, the drive will initially align the rotor (permanent magnet) to a position to optimize the starting torque. The alignment or ‘parking’ phase will introduce a short delay or pause that will be apparent to the operator at the start-up. However, this starting delay/parking is preferably limited so that it does not exceed a certain time limit, such as 250 or 500 ms and alignment of, for example, 1 second. The acceleration/soft start time (to rated speed) is similarly preferably limited to, for example, 1.5 seconds and the deceleration time (from rated speed) is preferably limited to, for example, 5 seconds.

During motor braking, some load energy will feed back to the drive. The braking torque may be controlled so that the braking energy will not cause the inverter DC link over voltage. Either fast or soft braking of the motor can be setup through microprocessor control discussed below. The allowable frequency of braking occurrences and start/stop duty cycle may be determined through test and assessment of braking resistor requirement. Preferably, braking torque control is set to be determined dynamically.

An exemplary control electronics adapts the PM motor IC control module IRMCK203 available from International Rectifier with an external microcontroller. The IRMCK203 is designed for complete closed loop current and velocity control of a high performance sensorless drive for PM motors. It has many internal registers and an external microcontroller may be programmed to dynamically control parameters of vector control algorithms embedded in the device.

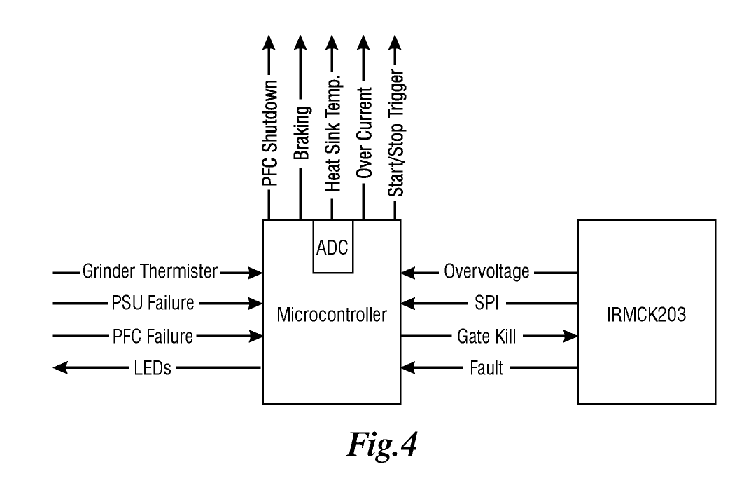

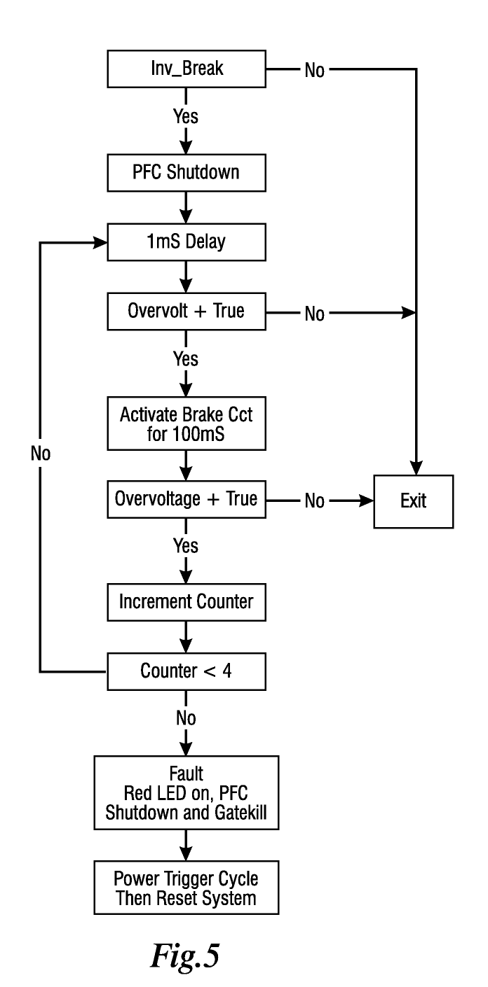

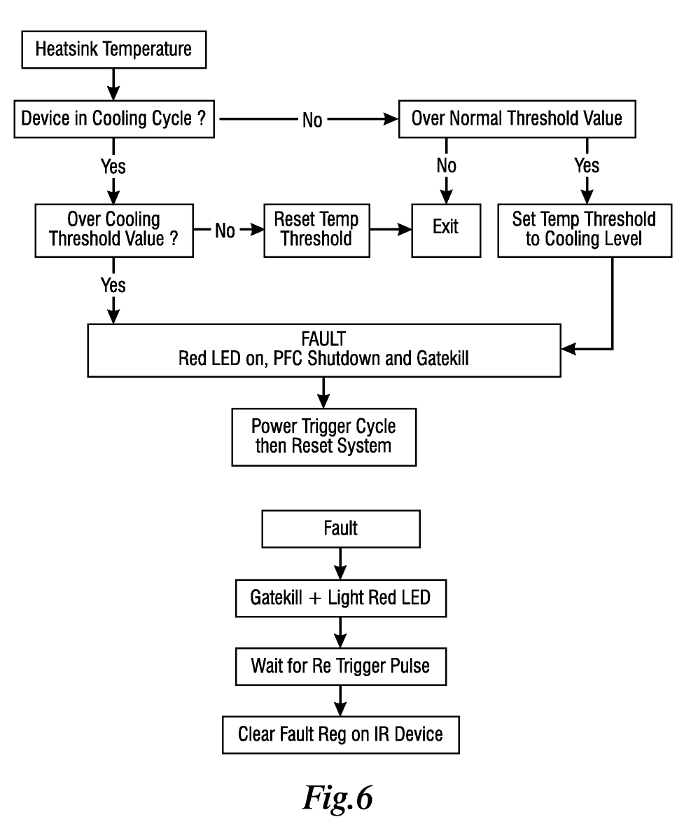

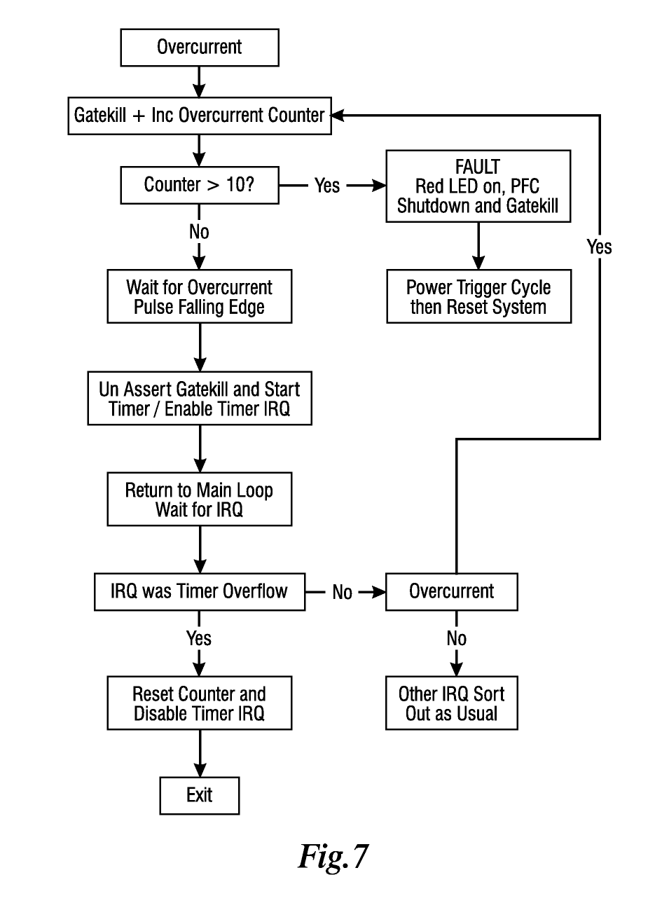

While the IRMCK203 controller IC may have many control functions built-in, design customization in software sets the application specific control parameters and, through both power electronics hardware and the control algorithm development, the control electronics are able to achieve a maximum 30,000 rpm motor speed at 2 kW load and up to 4 kW overload capability. An exemplary microcontroller interface is illustrated in FIGS. 4-7. FIG. 4 shows all the major connections to a suitable microcontroller, such as a PIC microcontroller, either from the microcontroller chip or elsewhere in the electronics.

More specifically, the controller IC by itself is not able to quickly control starting torque and acceleration rate (or soft start) to the extent desired by the characteristics discussed in this application. When the motor is started from standing still, the starting torque and acceleration is determined by the speed demand (the required motor speed). With a high speed such as 30,000 rpm, the controller IC would normally give a huge starting torque (up to the predefined maximum) and hence high acceleration rate. This is not desirable and not consistent with the desired torque profile, including soft start. Also, it causes an over current trip. Thus, the acceleration rate setting is not functioning at the start up and only works when the motor has already running at certain speed. The control electronics use a separate microcontroller or microprocessor to implement soft start by gradually increasing the speed demand. Also, for the start up, to have as soft and smooth start as possible, unnecessary high starting torque is avoided unless there is heavy loading at the start up. This is done by software in the separate processor.

Also, although the controller IC provides initial motor rotor alignment algorithm (necessary for brushless PM motor), it is preferred that the alignment time be very short so that user may not notice the delay. The IC can not work reliably if the alignment phase is set too short. Again, a unique software algorithm in a separate processor monitors the motor start-up and implements motor start-up ‘re-try’ algorithm to ensure successful start-up. By doing this, the alignment time can be very short.

As well as the various aspects addressed above, the microcontroller can provide monitoring and responding to events on the input and output connections. The options may include touch sensitive speed control and/or motor direction change. The touch sensitive speed control allows the user to control the speed up to a predefined maximum or maximum selectable at manufacture, by varying the amount of pressure applied to a trigger grip. The motor direction change allows the motor direction to be changed by having the microcontroller vary the state of the DIR pin on the IR chip. A high logic state can be used for one direction and a low logic state for the other direction.

An inverter uses an IGBT IPM module with specific thermal substrate and package design. Through motor control algorithm, full advantage is taken of the IGBT characteristics, and the inverter achieves very compact design and high efficiency. A Mitsubishi 5^{th} generation IGBT DIM-IPM module (PS21867 or open emitter version PS21067) may be used for the IPM module, although an additional braking IGBT will be required. IR2175 devices from International Rectifier may be used to measure the current at the output line to motor (floating measurement). A very low cost switched mode power supply may provide all the on-board control power supply requirements: 3.3V, 5V, 12V, etc. and isolated supply for external thermistor, start/stop switch, RS232 interface, etc.

The electronics may also include various user related features, such as a start/stop control, fault latching and LED indications. When receiving a ‘START’ signal (switch closed from the normally open position), the drive will start the motor. When a ‘STOP’ signal is received (switch opens), the motor will be stopped. There are preferably two levels of START/STOP interface: hardware and software. The START/STOP signal may not only feed into the on board microprocessor for software ON/OFF control, it may also be used to electronically enable/disable the inverter circuit.

When the drive is tripped as described below (due to over temperature or other faults), it should not start again. To reset the drive in the event of a fault or over-load condition arising, the drive will preferably reset only when the particular fault has cleared and the operator cycles the ON/OFF switch on the motor. LED indications are preferably provided for power on (preferably green color) and Fault (Motor Drive Fault, Over-temperature, Input Supply Failure) (preferably red color).

While the foregoing preferred embodiments of the invention have been described in some detail for purposes of clarity and understanding, it will be appreciated by one skilled in the art, from a reading of the disclosure that various changes in form and detail can be made without departing from the scope of the invention.

What is claimed is:

1. A power factor correction circuit, comprising:
a semiconductor integrated circuit;
at least one very low Rds(on) MOSFET; and
a silicon carbide diode for zero reverse recovery current.

2. The power factor correction circuit according to claim 1, further comprising a boost converter.

3. The power factor correction circuit according to claim 1, further comprising a pulse width modulation (PWM) controller.

4. The power factor correction circuit according to claim 1, wherein said at least one very low Rds(on) MOSFET comprises two very low RDS(on) MOSFETs connected in parallel.

5. An electronic control circuit for a brushless motor, comprising:
a power factor correction circuit, said power factor correction circuit having:
a semiconductor integrated circuit;
at least one very low Rds(on) MOSFET; and
a silicon carbide diode for zero reverse recovery current;
a microcontroller controlling said brushless motor; and
a processor connected to said microcontroller and to said power factor correction circuit, said processor executing control functions.

6. The electronic control circuit according to claim 5, wherein said power factor correction circuit further comprises a boost converter.

7. The electronic control circuit according to claim 5, wherein said power factor correction circuit further comprises a pulse width modulation (PWM) controller.

8. The electronic control circuit according to claim 5, wherein said at least one very low Rds(on) MOSFET comprises two very low RDS(on) MOSFETs connected in parallel.
